(19) United States
(12) Patent Application Publication
(10) Pub. No.: US 2015/0004575 A1
(43) Pub. Date: Jan. 1, 2015

(54) METHODS FOR IMPROVING PATIENT ADHERENCE TO A MOBILITY PROGRAM AND DEVICES THEREOF

(71) Applicant: Wipro Limited, Bangalore (IN)

(72) Inventor: Satish Prasad Rath, Bangalore (IN)

(73) Assignee: Wipro Limited, Bangalore (IN)

(21) Appl. No.: 13/963,085

(22) Filed: Aug. 9, 2013

(30) Foreign Application Priority Data
Jun. 27, 2013 (IN) 2813/CHE/2013

(51) Int. Cl. G09B 19/00

(52) U.S. Cl. CPC G09B 19/003
USPC 434/236

(57) ABSTRACT

A method, non-transitory computer readable medium, and a mobility program adherence device that obtains a mobility program for a patient including instructions for physical activities and an expected duration during a time period that the patient is to perform each of the physical activities. Data from an accelerometer of a patient monitoring device associated with the patient is received during at least a portion of the time period. The obtained data is processed to identify one or more of the physical activities performed by the patient. A duration the patient has performed the identified physical activities is determined. A graphical display including the determined duration the patient performed each of the physical activities during the at least a portion of the time period and an indication of the expected duration that the patient is to perform each of the physical activities during the time period is generated and output.

This application claims the benefit of Indian Patent Application Filing No. 2813/CHE/2013, filed Jun. 27, 2013, which is hereby incorporated by reference in its entirety.

### FIELD

This technology generally relates to methods and devices for monitoring patients and, more particularly, methods for improving patient adherence to a mobility program and devices thereof.

### BACKGROUND

Health care providers often prescribe mobility or activity plans, regimes, or charters (collectively referred to herein as “mobility programs”) to patients. The mobility programs include a set of instructions specifying recommended activities and associated durations the activities should be performed by a patient over a specified time period. In one typical example, a doctor may advise a patient recovering from surgery to be ambulatory (e.g., walking) or in certain physical position(s) (e.g., laying down or standing upright) for a duration of time over a specified time period, such as a number of days following the surgery. Compliance with mobility programs generally results in more effective healing and faster recovery. Additionally, compliance can prevent the development of undesirable conditions, such as deep vein thrombosis, for example.

While patient compliance with mobility programs is often poor, adherence to mobility programs also is not effectively monitored during the prescribed time period. Health care providers are unable to identify compliance issues during implementation of a mobility program. Therefore, a patient's failure to comply with a mobility program often goes unnoticed until the end of the prescribed time period.

At the end of the prescribed time period, health care providers generally request information regarding compliance from the patients. However, the patients often misrepresent the nature of their activities during the prescribed time period for a number of reasons including deliberately, due to the subjective nature of the assessment, or due to a lack of diligence in recording their activities, for example. Accordingly, health care providers lack the information required to modify a mobility program during implementation, or generate a new mobility program after the prescribed time period of an initial mobility program. As a result, health care providers cannot effectively mitigate the negative effects of poor compliance, leading to delayed recovery or other undesirable results for patients.

### SUMMARY

A method for improving patient adherence to a mobility program includes obtaining, with a mobility program adherence device, a mobility program for a patient, the mobility program comprising instructions for one or more physical activities and an associated expected duration during a specified time period that the patient is to perform each of the one or more physical activities. Data from at least an accelerometer of a patient monitoring device associated with the patient is received, with the mobility program adherence device, during at least a portion of the specified time period. The obtained data is processed, with the mobility program adherence device, to identify one or more of the physical activities performed by the patient. A duration that the patient has performed each of the identified one or more physical activities is determined, with the mobility program adherence device. A graphical display including at least the determined duration the patient performed each of the one or more physical activities during the at least a portion of the specified time period and an indication of the expected duration that the patient is to perform each of the one or more physical activities during the specified time period is generated and output, with the mobility program adherence device.

A non-transitory computer readable medium having stored thereon instructions for improving patient adherence to a mobility program comprising machine executable code which when executed by a processor, causes the processor to perform steps including obtaining a mobility program for a patient, the mobility program comprising instructions for one or more physical activities and an associated expected duration during a specified time period that the patient is to perform each of the one or more physical activities. Data from at least an accelerometer of a patient monitoring device associated with the patient is received during at least a portion of the specified time period. The obtained data is processed to identify one or more of the physical activities performed by the patient. A duration that the patient has performed each of the identified one or more physical activities is determined. A graphical display including at least the determined duration the patient performed each of the one or more physical activities during the at least a portion of the specified time period and an indication of the expected duration that the patient is to perform each of the one or more physical activities during the specified time period is generated and output.

A mobility program adherence device includes a processor coupled to a memory and configured to execute programmed instructions stored in the memory including obtaining a mobility program for a patient, the mobility program comprising instructions for one or more physical activities and an associated expected duration during a specified time period that the patient is to perform each of the one or more physical activities. Data from at least an accelerometer of a patient monitoring device associated with the patient is received during at least a portion of the specified time period. The obtained data is processed to identify one or more of the physical activities performed by the patient. A duration that the patient has performed each of the identified one or more physical activities is determined. A graphical display including at least the determined duration the patient performed each of the one or more physical activities during the at least a portion of the specified time period and an indication of the expected duration that the patient is to perform each of the one or more physical activities during the specified time period is generated and output.

This technology provides a number of advantages including methods, non-transitory computer readable medium, and a mobility program adherence device that easily and accurately monitor patient adherence to a mobility program. With this technology, an objective comparison of the actual duration a patient has performed the prescribed activities to the expected duration specified in the mobility program is generated and selectively output on a display screen and/or to a health care provider device. With the comparison information, a health care provider can facilitate compliance with and/or modify a mobility program during implementation, or recommend a new mobility program at the end of a prescribed time period, thereby decreasing patient recovery time.

### BRIEF DESCRIPTION OF THE DRAWINGS

FIG. 1 is a block diagram of an exemplary network environment which incorporates an exemplary mobility program adherence device coupled to patient monitoring device(s);

FIG. 2 is a flowchart of an exemplary method for improving patient adherence to a mobility program; and

FIG. 3 is a screen shot of an exemplary interface which includes an exemplary graphical display including actual and expected performance information for activities specified in a mobility program for a patient.

### DETAILED DESCRIPTION

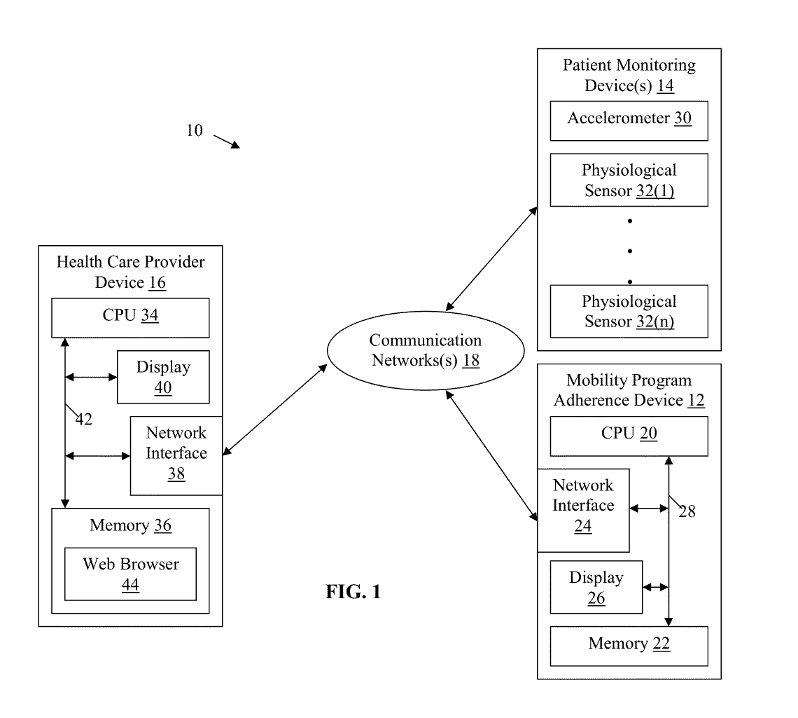

An exemplary environment 10 with a mobility program adherence device 12 coupled to patient monitoring device(s) 14 and a health care provider device 16 by communication network(s) 18 is illustrated in FIG. 1, although this environment 10 can include other numbers and types of systems, devices, components, and elements in other configurations, such as multiple mobility program adherence devices or communication networks. While not shown, the environment 10 also may include additional network components, such as routers, switches and other devices, which are well known to those of ordinary skill in the art and thus will not be described here. This technology provides a number of advantages including methods, non-transitory computer readable medium, and a mobility program adherence device that easily and accurately monitor patient adherence to a mobility program.

The mobility program adherence device 12 includes a central processing unit (CPU) 20 including one or more processors, a memory 22, a network interface 24, and an optional display 26, which are coupled together by a bus 28 or other link, although other numbers and types of systems, devices, components, and elements in other configurations and locations can also be used. The CPU 20 in the mobility program adherence device 12 executes a program of stored instructions for one or more aspects of the present technology, as described and illustrated by way of the examples herein. Other types and numbers of processing devices and configurable hardware logic also could be used and the CPU 20 could execute other numbers and types of programmed instructions.

The memory 22 in the mobility program adherence device 12 stores these programmed instructions for one or more aspects of the present technology, as described and illustrated herein, although some or all of the programmed instructions could be stored and executed elsewhere. Optionally, the memory 22 of the mobility program adherence device 12 includes one or more databases for storing data provided by the patient monitoring device(s) 14. The databases also optionally include a reference database of clinical guidelines for physical activities, which can be used to generate mobility programs for patients, as described and illustrated later. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the CPU 20, can be used for the memory 22.

The network interface 24 in the mobility program adherence device 12 is used to operatively couple and communicate via the communication network(s) 18 between at least the mobility program adherence device 12 and the patient monitoring device(s) 14, and optionally the health care provider device 16. By way of example only, the communication network(s) 18 could include one or more local area networks (LANs) or one or more wide area networks (WANs) that use TCP/IP over Ethernet and industry-standard protocols, although other types and numbers of communication networks having their own communication protocols can be used. Other types and numbers of communication networks or systems with other types and numbers of connections and configurations can also be used.

The optional display 26 of the mobility program adherence device 12 can be configured to output information stored in the memory 22, as described and illustrated later. The display can be a touchscreen or computer monitor, for example, although any other type of device capable of graphically presenting information can also be used. In one example, the mobility program adherence device 12 includes the display 26 and is a central nursing station computing apparatus or nurse's tablet computing device in a hospital or other health care environment, for example.

In another example, the mobility program adherence device 12 acts as a server computing device that does not include a display and instead outputs any generated graphical displays to the health care provider device 16 upon request using the communication network(s) 18. In this example, the mobility program adherence device 12 processes requests received from the health care provider device 20 via the communication network(s) 18 according to the HTTP-based application RFC protocol, for example. Various network processing applications, HTTP Web Server applications, and/or FTP applications, may be operating on the mobility program adherence device 12 and transmitting content (e.g., files, Web pages) to the health care provider device 16 in response to requests for the content from the health care provider device 16.

The patient monitoring device(s) 14 include at least an accelerometer 30 and, optionally, physiological sensors 38(1)-38(2). The accelerometer 30 can be a two or three axis micro electro-mechanical system (MEMS) linear accelerometer, for example, although other types of accelerometers can also be used. The accelerometer 30 can include motion detection circuitry for determining motion, such as magnitude and direction of acceleration, and for providing a digital output representative of the motion.

The physiological sensors 32(1)-32(2) can include an electrocardiogram sensor, a heart rate monitor, a blood pressure sensor, a temperature sensor, a respiratory rate sensor, and/or a pulse oximeter, for example, although other physiological sensors can also be used. Also optionally, the patient monitoring device(s) 14 can include one or more non-physiological sensors, such as additional accelerometers, a global positioning system (GPS) sensor, and/or a gyroscope, for example. In this example, the patient monitoring device(s) 14 are configured to communicate data to the mobility program adherence device 12 via the communication network(s) 18 through a network interface, for example.

The health care provider device 16 in this example includes a central processing unit (CPU) 34 including one or more processors, a memory 36, a network interface 38, and a display 40, which are coupled together by a bus 42 or other link. The health care provider device 16 can also have other numbers and types of systems, devices, components, and elements in other configurations and locations. The CPU 34 in the health care provider device 16 executes a program of stored instructions for one or more aspects of the present technology as described and illustrated by way of the examples herein, although other types and numbers of processing devices and configurable hardware logic could be used and the CPU 34 could execute other numbers and types of programmed instructions.

The memory 36 in the health care provider device 16 stores these programmed instructions for one or more aspects of the present technology, as described and illustrated herein, although some or all of the programmed instructions could be stored and/or executed elsewhere. The memory 36 optionally stores programmed instructions for a Web browser 44 for communicating with the network interface 38 to operatively exchange content with the mobility program adherence device 12. A variety of different types of memory storage devices, such as a random access memory (RAM), read only memory (ROM), floppy disk, hard disk, CD-ROM, DVD-ROM, or other computer readable medium which is read from and written to by a magnetic, optical, or other reading and writing system that is coupled to the CPU 34, can be used for the memory 36.

The network interface 38 in the health care provider device 16 is used to operatively couple and communicate between the health care provider device 16 and the mobility program adherence device 12 via the communication network(s) 18, although other types and numbers of communication networks, connections, or configurations can also be used. The display 40 of the health care provider device 16 can be configured to communicate with the Web browser 44, for example, to output or render information, such as Web pages, as described and illustrated later. The display can be a touchscreen or computer monitor, for example, although any other type of device capable of graphically presenting information can also be used.

Although examples of the mobility program adherence device 12 patient monitoring device(s) 14, and health care provider device 16, which are coupled together via the communication network(s) 18, are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, or micro-controllers, programmed according to the teachings of the examples, as described and illustrated herein, and as will be appreciated by those ordinary skill in the art.

In addition, two or more computing systems or devices can be substituted for any one of the systems in any embodiment of the examples. Accordingly, principles and advantages of distributed processing, such as redundancy and replication also can be implemented, as desired, to increase the robustness and performance of the devices and systems of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, or combinations thereof.

The examples may also be embodied as a non-transitory computer readable medium having instructions stored thereon for one or more aspects of the present technology as described and illustrated by way of the examples herein, as described herein, comprising machine executable code which when executed by a processor, cause the processor to carry out the steps necessary to implement the methods of the examples, as described and illustrated herein.

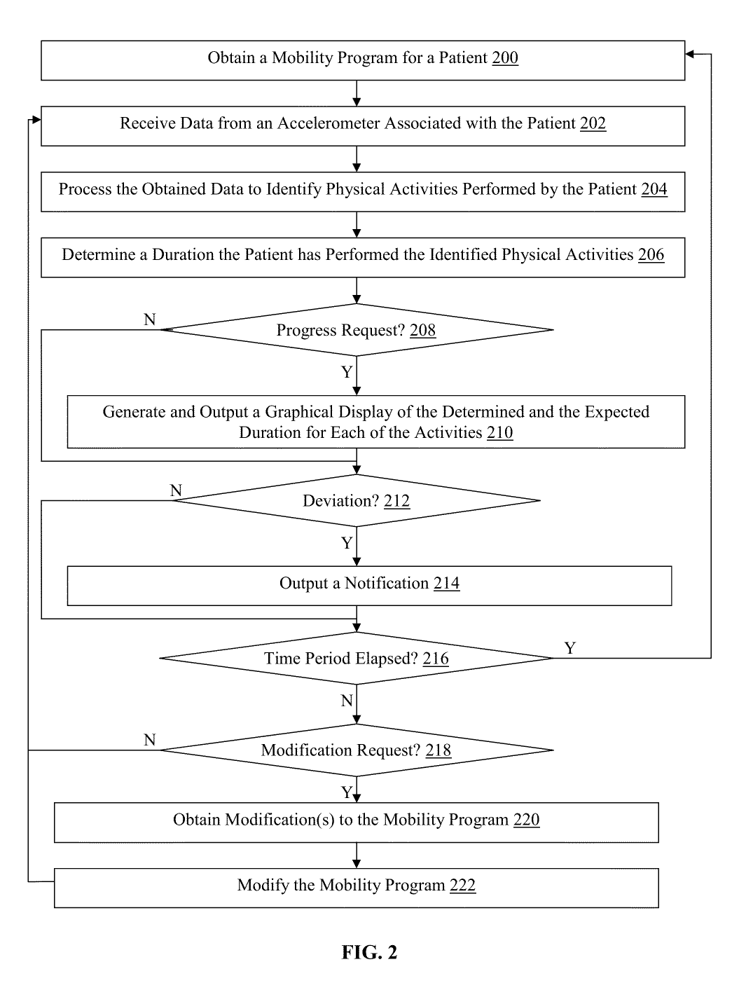

Exemplary methods and devices for improving patient adherence to a mobility program will now be described with reference to FIGS. 1-3. Referring more specifically to FIG. 2, in step 200 the mobility program adherence device 12 obtains a mobility program assigned to a patient from memory 22, although the mobility program can be stored in other locations and obtained in other manners as described with examples herein. The mobility program includes one or more activities and a designated time period which is set for completion of the mobility program. Additionally, the mobility program further includes an expected duration the patient is to perform each of the activities during the time period. In this example, the activities can include ambulatory movements (e.g., walking, running, sitting up, or stretching) or stationary positions (e.g., sitting upright, lying down, or inclined).

In one example, the mobility program adherence device 12 obtains the mobility program by communicating with the health care provider device 16 associated with a health care provider for the patient. Accordingly, the mobility program adherence device 12 can generate and send to the health care provider device 16 a display including a template form, for example, that can be prefilled. The prefilled information for the template form can be retrieved from information stored in a reference database in the memory 22.

The reference database can store recommended mobility programs, or portions of mobility programs (e.g., individual activities and associated durations), as associated with health condition(s) or procedure(s) and/or patient demographic attributes. The health condition(s) or procedure(s) and demographic attributes associated with the patient can be stored by, and retrieved by the mobility program adherence device 12 from, an electronic medical record (EMR) or other hospital management system, for example.

Accordingly, in one example, the mobility program adherence device 12 receives a request via communication network(s) 18 from a health care provider using the health care provider device 16 to establish a mobility program for a patient. Using identifying information in the request, the mobility program adherence device 12 can retrieve a health procedure (e.g., heart surgery) recently performed on the patient and demographic attributes (e.g., male and 65 years old) from an EMR associated with the patient.

The mobility program adherence device 12 can then query the reference database in the memory 22 based on the health procedure and demographic attributes, to retrieve a reference mobility program. The mobility program adherence device 12 can then fill a template form with the contents of the reference mobility program and send the template form to the health care provider device 16 so that the health care provider can review, modify, and/or approve the mobility program for the patient and submit the mobility program to the mobility program adherence device 12 for storage in the memory 22. Upon obtaining the mobility program for the patient in step 200, the mobility program adherence device 12 can store the mobility program in the memory 22 as associated with the patient.

Optionally, the mobility program adherence device 12 can further store the mobility program, or portions thereof, along with other information (e.g. the health procedure and/or demographic attributes for the patient) in the reference database to be used later as a reference mobility program Alternatively, the mobility program adherence device 12 can use information associated with the obtained mobility program to modify reference mobility program(s) stored in the reference database in the memory 22. Thereby, the mobility program adherence device 12 can learn over time and improve the accuracy of mobility programs recommended to health care providers. In other examples, the mobility program adherence device 12 does not include a reference database and the template form provided to the health care provider device 16 is not prefilled and instead requires the health care provider to input and submit the activities, associated durations, and time period for the mobility program to the mobility program adherence device 12.

Additionally, another network device, such as a server computing device connected to the communication network(s) 18, can facilitate input of the mobility program and the mobility program adherence device 12 can obtain the mobility program for the patient from the other network device in step 200. In other examples, a health care provider interacts directly with the mobility program adherence device 12 to input the mobility program using the display 26 and an input interface and input device. Other methods of obtaining a mobility program for a patient can also be used.

In step 202, the mobility program adherence device 12 receives data from the patient monitoring device(s) 14, including data from the accelerometer 30, via the communication network(s) 18, although other types and amounts of data could be received. In this example, the accelerometer 30 is associated with the patient, such as attached to the patient in a body-worn device, implanted in the patient, or connected to a nearby or bed-side monitoring and/or tracking system, for example. Upon receiving the data from the patient monitoring device(s) 14, the data is optionally stored in the memory 22 as associated with the patient.

In some examples, the received data can be stored locally by the patient monitoring device(s) 14 and communicated to the mobility program adherence device 12 periodically, upon request from the mobility program adherence device 12, or whenever network connectivity is available, such as in the case of a patient that is being monitored remotely, for example. Alternatively, the data can be communicated by the patient monitoring device(s) 14 continuously and/or in real-time, such as in the case of a patient monitored locally that may be present in a hospital, for example.

In step 204, the mobility program adherence device 12 processes the data obtained in step 200 to identify one or more physical activities performed by the patient. In this example, the mobility program adherence device 12 only processes data obtained from the patient monitoring device(s) 14 during the time period specified in the mobility program for the patient, as obtained in step 200 and stored in the memory 22. Optionally, the mobility program adherence device 12 may disregard data that, when processed, is indicative of an activity not identified in the mobility program for the patient.

While some activities (e.g. walking) may be relatively accurately identified through classification of the data output by the accelerometer 30, other activities may be identified more accurately by processing additional data obtained from one or more other sensors. For example, some activities may be more accurately identified, or only identifiable, using data output by one or more other accelerometer(s), a gyroscope, and/or one or more of the physiological sensors 32(1)-32(n). Accordingly, the data output by the other sensors can be processed separately from, and/or can be correlated with, the data output by the accelerometer 30 in order to identify physical activities performed by the patient in step 204.

In step 206, the mobility program adherence device 12 determines a duration the patient has performed each of the physical activities identified in step 204. Accordingly, the mobility program adherence device 12 can process the data and identify a change in the data indicative of the beginning of an activity and a change in the data indicative of the end of the activity to determine a duration the patient has performed the activity.

In this example, the mobility program adherence device 12 can determine whether the memory 22 includes an indication of a prior performance of the identified physical activity by the patient during the specified time period of the mobility program. If the mobility program adherence device 12 determines the patient has previously performed the identified activity within the time period specified in the mobility program, then the determined duration can be added to the duration associated with the activity that is stored in the memory 22.

If the mobility program adherence device 12 determines the patient has not previously performed the identified activity within the time period specified in the mobility program, then the determined duration can be stored in a new record in the memory 22, corresponding to the patient, as associated with the identified activity. Optionally, a timestamp can also be stored in the memory 22 so that a health care provider can subsequently determine when the physical activity was performed. Accordingly, in this example, the mobility program adherence device 12 maintains a running total of the duration during the specified time period that the patient has performed each of the identified activities.

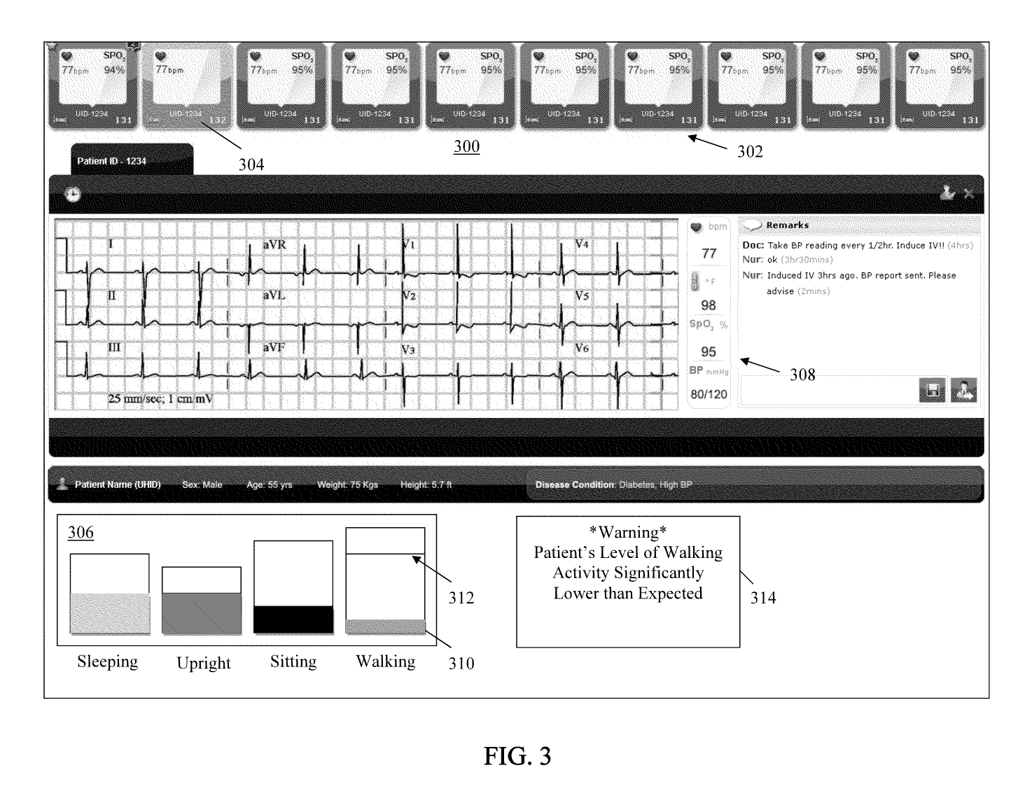

In step 208, the mobility program adherence device 12 determines whether it has received a request for progress with respect to the mobility program associated with the patient. A request can be received through an interface provided by the mobility program adherence device 12. Referring to FIG. 3, a screen shot of an exemplary interface 300 is illustrated. In this example, the interface 300 is output to the display 26 at a central nursing station computing apparatus and includes a plurality of icons 302 associated with each patient monitored by the central nursing station computing apparatus. A user can initiate a request for a patient's progress with respect to a mobility program by selecting one of the plurality of icons 302, such as icon 304, for example. A corresponding or different Web-based interface configured to receive a request for the patient's progress with respect to the mobility program can be provided to the health care provider device 16 upon request.

Optionally, the processing of step 204 and/or the determining of step 206 can be performed in real-time or periodically, as described and illustrated earlier. Alternatively, the processing of step 204 and/or the determining of step 206 can be performed upon receiving a request from a user of the mobility program adherence device 12, such as a health care provider utilizing the health care provider device 16, for example. If the mobility program adherence device 12 determines in step 208 that it has received a progress request, then the Yes branch is taken to step 210.

In step 210, the mobility program adherence device 12 generates and outputs a graphical display including at least the determined duration and an indication of the expected duration for each of the activities specified in the mobility program associated with the patient.

Referring to FIG. 3, the interface 300 includes an exemplary graphical display 306 including actual and expected performance information for activities specified in the mobility program for the patient. Optionally, the mobility program adherence device 12 is further configured to output at least a portion of the received data 308 in a processed and/or raw format, such as any data received from the physiological sensors 32(1)-32(n), for example.

In this example, the graphical display 306 includes a bar graph for each of the activities specified in the patient's mobility program, which in this example include sleeping, upright, sitting, and walking The graphical display 306 further includes expected performance information including a duration of performance of each of the activities that is expected at the current time of the progress request, which, in this example, includes only a portion of the time period specified in the mobility program.

The expected duration can be specified in the mobility program or can be determined by the mobility program adherence device based on a proportion of the time period that has elapsed at the time of the progress request, for example. In this example, the patient has performed the sleeping, upright, and sitting activities for the expected duration. However, the duration 310 that the patient has performed the walking activity is less than the expected duration 312. Other types of graphs and/or graphical displays with other information can also be generated by the mobility program adherence device 12.

The graphical display 306 can be output to the display 26 in examples in which the mobility program adherence device 12 is a central nursing station computing apparatus. In another example, the mobility program adherence device 12 outputs the graphical display 306 by sending the graphical display 306, such as in the form of a Web page, to the health care provider device 16 via the communication network(s) 18 for output on the display 40. Other methods of outputting the graphical display 306 can also be used.

Referring back to FIG. 2, if the graphical display is generated and output in step 210 or, if the mobility program adherence device 12 determines, in step 208, that it has not received a request for progress and the No branch is taken, then the mobility program adherence device 12 proceeds to step 212. In step 212, the mobility program adherence device 12 optionally determines whether the determined duration that each activity has been performed by the patient deviates from the corresponding expected duration by at least a threshold.

Optionally, irrespective of a progress request, steps 212-214 can be performed by the mobility program adherence device 12 periodically or at any other specified time(s), such as when the time period has elapsed, as described and illustrated in more detail later. If the mobility program adherence device 12 determines in step 212 that the determined duration deviates from the corresponding expected duration for at least one of the activities specified in the mobility program, then the Yes branch is taken to step 214.

In step 214, the mobility program adherence device 12 outputs a notification in response to the determination of a deviation. In this example, the mobility program adherence device 12 determines that the determined duration 310 that the patient performed the walking activity significantly deviates from the duration 312 that the patient was expected to perform the walking activity. Accordingly, the mobility program adherence device 12 outputs a notification in the form of a visual notification 314 included on the interface 300. In other examples, the notification can be an audible notification or an electronic message sent to the health care provider device 16, for example, although other types of notifications can also be used.

If a notification is output in step 214 or, if the mobility program adherence device 12 determines, in step 212, that the determined duration does not deviate from the corresponding expected duration for any of the activities specified in the mobility program and the No branch is taken, then the mobility program adherence device 12 proceeds to step 216. In step 216, the mobility program adherence device 12 determines whether the time period specified in the mobility program for the patient has elapsed. The mobility program adherence device 12 can determine whether the time period has elapsed based on a comparison of a time at which the mobility program was established in step 200 with a current time, for example.

If the mobility program adherence device 12 determines that the time period specified in the mobility program has elapsed, then the Yes branch is taken to step 200 and a new mobility program for the same or a different patient may be obtained, as described and illustrated earlier. If the mobility program adherence device 12 determines, in step 222, that the time period specified in the mobility program has not elapsed, then the No branch is taken to step 218. Optionally, irrespective of a progress request or a deviation determination, step 216 can be performed by the mobility program adherence device 12 periodically or at any other specified time(s).

In step 218, the mobility program adherence device 12 determines whether it has received a request to modify the mobility program associated with the patient. A modification request can be submitted by a health care provider using the mobility program adherence device 12 in response to user interaction with an input element, such as a button, included in the interface 300 and/or graphical display 306, for example. Alternatively, the mobility program adherence device 12 can receive a modification request submitted through a Web-based interface provided by the mobility program adherence device 12 to the health care provider device 16. Other methods of receiving a modification request can also be used. If the mobility program adherence device 12 determines in step 218 that a modification request has not been received, then the No branch is taken to step 202 and the mobility program adherence device 12 continues to receive data, as described and illustrated earlier.

If the mobility program adherence device 12 determines in step 218 that a modification request has been received, then the Yes branch is taken to step 220. In step 220, the mobility program adherence device 12 obtains one or more modifications to the mobility program for the user. Accordingly, the mobility program adherence device 12 can generate and output a modification interface configured to facilitate modification of the patient's mobility program in response to a request to the modification request. The modification interface can be a display screen output to the display 26 or a Web page sent to the health care provider device 16, for example. Optionally, the modification interface corresponds to the template form used to initially obtain the mobility program in step 200 and is prefilled with information associated with the current mobility program that is being implemented by the patient.

The mobility program can be modified to increase or decrease the time period, add or remove one or more activities, increase or decrease the duration the patient is expected to perform one or more of the activities, or alter any other parameter of the mobility program. Upon submission of the modification(s) to the mobility program, in step 222, the mobility program adherence device 12 modifies the mobility program associated with the patient and stores the modified mobility program in the memory 22. Subsequent to modifying the mobility program, the mobility program adherence device 12 proceeds to step 202 and continues to receive data, as described and illustrated earlier.

Optionally, irrespective of a progress request, a deviation determination, or a determination as to whether the time period has elapsed, steps 218-222 can be performed by the mobility program adherence device 12 periodically or at any other specified time(s). Additionally, in examples in which the data that is received in step 202 is continuously communicated and/or communicated in real-time, step 202, and optionally one or more of steps 204 and step 206, can be performed in parallel to any of steps 210-222 so that all data output by the patient monitoring device(s) 14 is captured.

By this technology, patient compliance with a mobility program can be monitored and deviations between actual and expected performance by a patient of any of the activities specified in the mobility program can be identified. In response to the identified deviations, or for any other reason, a mobility program can advantageously be modified by a health care provider during implementation to mitigate negative effects of a patient's failure to adhere to the mobility program. Accordingly, with this technology, patient recovery from a health condition can be improved and the time for recovery can be reduced.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for improving patient adherence to a mobility program, the method comprising:
obtaining, with an mobility program adherence device, a mobility program for a patient, the mobility program comprising instructions for one or more physical activities and an associated expected duration during a specified time period that the patient is to perform each of the one or more physical activities;
receiving, with the mobility program adherence device, data from at least an accelerometer of a patient monitoring device associated with the patient during at least a portion of the specified time period;
processing, with the mobility program adherence device, the obtained data to identify one or more of the physical activities performed by the patient;
determining, with the mobility program adherence device, a duration the patient has performed each of the identified one or more physical activities; and
generating and outputting, with the mobility program adherence device, a graphical display including at least the determined duration the patient performed each of the one or more physical activities during the at least a portion of the specified time period and an indication of the expected duration that the patient is to perform each of the one or more physical activities during the specified time period.

2. The method of claim 1, wherein the method further comprises:
determining, with the mobility program adherence device, an expected duration for the at least a portion of the specified time period for each of the one or more activities based on the expected duration during the specified time period;
determining, with the mobility program adherence device, whether the determined duration deviates from the expected duration for the at least a portion of the specified time period by at least a threshold for any of the one or more activities; and
outputting, with the mobility program adherence device, a notification, when it is determined that the determined duration deviates from the expected duration for the at least a portion of the specified time period by at least a threshold for any of the one or more activities.

3. The method of claim 2, wherein the notification is at least one of an audible notification, a visual notification, or an electronic message to a health care provider.

4. The method of claim 1, wherein:
the receiving further comprises receiving data from a physiological sensor, an electrocardiogram sensor, a heart rate monitor, a blood pressure sensor, a temperature sensor, a respiratory rate sensor, or a pulse oximeter of the patient monitoring device; and
the graphical display further includes at least a portion of the received data.

5. The method of claim 1, further comprising:
obtaining, with the mobility program adherence device, one or more modifications to the mobility program from a computing device associated with a health care provider;
modifying, with the mobility program adherence device, the mobility program for the patient based on the one or more modifications; and
repeating at least the receiving and processing steps based on the modified mobility program.

6. The method of claim 1, wherein the generating and outputting further comprises at least one of outputting the graphical display to a display of a nursing station computing apparatus or sending the graphical display to a health care provider device for output on a display of the health care provider device.

7. A non-transitory computer readable medium having stored thereon instructions for improving patient adherence to a mobility program comprising machine executable code which when executed by a processor, causes the processor to perform steps comprising:
obtaining a mobility program for a patient, the mobility program comprising instructions for one or more physical activities and an associated expected duration during a specified time period that the patient is to perform each of the one or more physical activities;
receiving data from at least an accelerometer of a patient monitoring device associated with the patient during at least a portion of the specified time period;
processing the obtained data to identify one or more of the physical activities performed by the patient;
determining a duration the patient has performed each of the identified one or more physical activities; and
generating and outputting a graphical display including at least the determined duration the patient performed each of the one or more physical activities during the at least a portion of the specified time period and an indication of the expected duration that the patient is to perform each of the one or more physical activities during the specified time period.

8. The medium of claim 7 wherein the at least a portion of the specified time period comprises the entire specified time period and the medium further comprises machine executable code which, when executed by the processor, causes the processor to perform steps further comprising:
determining an expected duration for the at least a portion of the specified time period for each of the one or more activities based on the expected duration during the specified time period;
determining whether the determined duration deviates from the expected duration for the at least a portion of the specified time period by at least a threshold for any of the one or more activities; and
outputting a notification, when it is determined that the determined duration deviates from the expected duration for the at least a portion of the specified time period by at least a threshold for any of the one or more activities.

9. The medium of claim 8 wherein the notification is at least one of an audible notification, a visual notification, or an electronic message to a health care provider.

10. The medium of claim 7 wherein:
the receiving further comprises receiving data from a physiological sensor, an electrocardiogram sensor, a heart rate monitor, a blood pressure sensor, a temperature sensor, a respiratory rate sensor, or a pulse oximeter of the patient monitoring device; and
the graphical display further includes at least a portion of the received data.

11. The medium of claim 7 further comprising machine executable code which, when executed by the processor, causes the processor to perform steps further comprising:
obtaining one or more modifications to the mobility program from a computing device associated with a health care provider;
modifying the mobility program for the patient based on the one or more modifications; and
repeating at least the receiving and processing steps based on the modified mobility program.

12. The medium of claim 7 wherein the generating and outputting further comprises at least one of outputting the graphical display to a display of a nursing station computing apparatus or sending the graphical display to a health care provider device for output on a display of the health care provider device.

13. A mobility program adherence device, comprising:
a processor coupled to a memory and configured to execute programmed instructions stored in the memory, comprising:
obtaining a mobility program for a patient, the mobility program comprising instructions for one or more physical activities and an associated expected duration during a specified time period that the patient is to perform each of the one or more physical activities;
receiving data from at least an accelerometer of a patient monitoring device associated with the patient during at least a portion of the specified time period;
processing the obtained data to identify one or more of the physical activities performed by the patient;
determining a duration the patient has performed each of the identified one or more physical activities; and
generating and outputting a graphical display including at least the determined duration the patient performed each of the one or more physical activities during the at least a portion of the specified time period and an indication of the expected duration that the patient is to perform each of the one or more physical activities during the specified time period.

14. The device of claim 13 wherein the at least a portion of the specified time period comprises the entire specified time period and the processor is further configured to execute programmed instructions stored in the memory further comprising:
determining an expected duration for the at least a portion of the specified time period for each of the one or more activities based on the expected duration during the specified time period;
determining whether the determined duration deviates from the expected duration for the at least a portion of the specified time period by at least a threshold for any of the one or more activities; and
outputting a notification, when it is determined that the determined duration deviates from the expected duration for the at least a portion of the specified time period by at least a threshold for any of the one or more activities.

15. The device of claim 14 wherein the notification is at least one of an audible notification, a visual notification, or an electronic message to a health care provider.

16. The device of claim 13 wherein:
the receiving further comprises receiving data from a physiological sensor, an electrocardiogram sensor, a heart rate monitor, a blood pressure sensor, a temperature sensor, a respiratory rate sensor, or a pulse oximeter of the patient monitoring device; and
the graphical display further includes at least a portion of the received data.

17. The device of claim 13 wherein the processor is further configured to execute programmed instructions stored in the memory further comprising:
obtaining one or more modifications to the mobility program from a computing device associated with a health care provider;
modifying the mobility program for the patient based on the one or more modifications; and
repeating at least the receiving and processing steps based on the modified mobility program.

18. The device of claim 13 wherein the generating and outputting further comprises at least one of outputting the graphical display to a display of a nursing station computing apparatus or sending the graphical display to a health care provider device for output on a display of the health care provider device.
